(19) United States
(12) Patent Application Publication
(10) Pub. No.: US 2003/0229699 A1
(43) Pub. Date: Dec. 11, 2003

(54) Method of limiting media description negotiation

(76) Inventors: Timothy L. Moran, Argyle, TX (US); Kaiser Chen, Irving, TX (US); Sreenivas Addagatla, Irving, TX (US); Shavantha Kularatna, Flower Mound, TX (US); Basavaraj Patil, Coppell, TX (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/163,615

(22) Filed: Jun. 7, 2002

(51) Int. Cl. G06F 15/173

(52) U.S. Cl. 709/227; 709/223

(57) ABSTRACT

A method of limiting the media description negotiation in Mobile IP networks, comprising the steps of: filtering, by a proxy call state control means (P-CSCF), a media description list of a user equipment (UE; UE-O, UE-T) based on policy constraints of networks which are involved in a communication connection of said user equipment (UE; UE-O, UE-T); and establishing a communication connection of said user equipment (UE; UE-O, UE-T), wherein a media description list for said communication connection is negotiated by said proxy call state control means (P-CSCF).

### FIELD OF THE INVENTION

The present inventions relates to a method of limiting the media description negotiation in Mobile IP (Internet Protocol) networks, particularly in networks which are based on the Session Initiation Protocol (SIP).

### PRIOR ART

With respect to wireless all IP networks using SIP call control, the 3^{rd} Generation Partnership Project (3GPP) has defined the use of the Internet Engineering Task Force's SIP protocol for call and session establishment and control. It was intended for the transmission of audio and video data over IP networks and offers a relative small complexity, while being easy to implement. Substantially, the Session Initiation Protocol (SIP) is based on the Hypertext Transfer Protocol (HTTP). The Session Initiation Protocol (SIP) was designed with wired networks in mind and powerful clients capable of doing end-end service negotiation, i.e. ample bandwidth Large Area Networks (LAN) and clients with plenty of processing capability, memory, and power.

IP networks of the third generation require an optimal use of resources such as the radio frequency (RF) and the mobile battery's lifetime. However, plenty of bandwidth and battery are assumptions of wired networks that do not apply to wireless networks. IP protocols such as the Session Initiation Protocol (SIP) must be optimized to make efficient use of the wireless network and wireless terminals.

Wired IP networks charge flat rates for access and provide a best effort service. Wireless access networks require more robust service offering. To do so requires policing of access attempts before resources are allocated. This is especially true for a mobile-mobile call.

Moreover, as mentioned above, the media description negotiation in the Session Initiation Protocol (SIP) is defined as an end-end process. Each user agent sends its entire list of available media descriptions, wherein the end points select which media description option(s) to use in the media streams. The exchanged lists do not even have to define a conclusive single media description for each media stream. All that is needed is that at least one media description acceptable by both ends is exchanged. The actual media description used may be determined via overhead information in the media stream itself. For example, the Real-Time Transfer Protocol (RTP) payload type field may specify the actual coding scheme used. This approach is scalable in that it does not require network involvement. However, it prevents the wireless network from managing access policy early in the process. It also requires redundant processing in the mobiles to perform the negotiation (redundant for each call) across the air interface when the process can be done (proxied) by the network. Furthermore, an end-end negotiation may be overruled when the actual resources are negotiated for by the access networks (e.g. Packet Data Protocol (PDP) context activation), thus negating (minimally modifying) prior agreements for resources (resource types/formats).

### SUMMARY OF THE INVENTION

Therefore, it is an object of the present invention to deal with the above mentioned problems.

In order to solve this object, there is provided a method of limiting the media description negotiation in Mobile IP networks, comprising the steps of: filtering, by a proxy call state control means, a media description list of a user equipment based on policy constraints of networks which are involved in a communication connection of said user equipment; and establishing a communication connection of said user equipment, wherein a media description list for said communication connection is negotiated by said proxy call state control means.

In addition, there is provided a proxy switching device for limiting the media description negotiation in Mobile IP networks, comprising: filtering means for a media description list of a user equipment based on policy constraints of networks which are involved in a communication connection of said user equipment; and negotiation means for a media description list for said communication connection.

Still further, there is provided a Mobile IP network capable of limiting the media description negotiation, which comprises a proxy switching device as defined above.

According to the solution of the present invention, an early network involvement in policing access as well as minimizing and even mitigating the need for mobile media description negotiation is permitted. That is, the determination of resource types in both the originating and terminating networks is done prior to an actual allocation process involving an gateway node. The involvement of a mobile is still supported but not required. The media description list is e.g. a codec list, i.e. the codecs which a device is capable of using (such as AMR, G.711, G.729 etc.).

Thus, according to the present invention it is possible to optimize the media description negotiation process that is common to the Session Initiation Protocol (SIP), while allowing a policy control by the IP multimedia (IM) subsystem (including call state control functions (CSCF)).

For example, in an IP multimedia (IM) subsystem performing the method according to the present invention it is possible to specify a policy control as a function of a proxy call state control function (P-CSCF). This call state control function (as well as a Serving CSCF) may be modified to support limited media description negotiation between mobiles (user equipment devices—UE).

Furthermore, instead of mobiles exchanging media description parameters end-end, according to the present invention, the media description list can be filtered at both the originating mobile's P-CSCF and the terminating mobile's P-CSCF. These proxies observe the mobiles media description list and filter it based on the policy constraints of the access and core network.

A further enhancement is that the proxies may store the mobile's media description capabilities at the time of registration (or to retrieve the information from the HSS) and thus supply the media description parameters for the mobile. That is, once registered, a wireless device does not need to provide the media description parameters at all (just the service type as in video or audio). Based on the requested service (Session Description Protocol (SDP) media types) the proxy determines the media description list on behalf of the mobile terminal scoping it to the current conditions of the relevant network. In a mobile-mobile call this process is done at both the originating network and terminating network such that when an “INVITE”-message is received at the terminating mobile, the choice may already be made without requiring sending of the parameters or mobile negotiation.

A decrease of the parameters may be effected by using a compression process. However, this method does not require the parameters to be sent and permits an early network involvement in the negotiation phase as opposed to a separate negotiation (re-negotiation) phase after the end points have done their negotiation, i.e. a Packet Data Protocol (PDP) context negotiation is avoided which may negate the end-end negotiation.

Further details and modifications of the present invention can be derived from the following description of the preferred embodiments which is to be taken in conjunction with the drawings.

### BRIEF DESCRIPTION OF THE DRAWINGS

FIG. 1 shows the registering of media description capabilities; and

FIG. 2 shows a session establishment using an already filtered set of media descriptions

### DESCRIPTION OF THE PREFERRED EMBODIMENTS

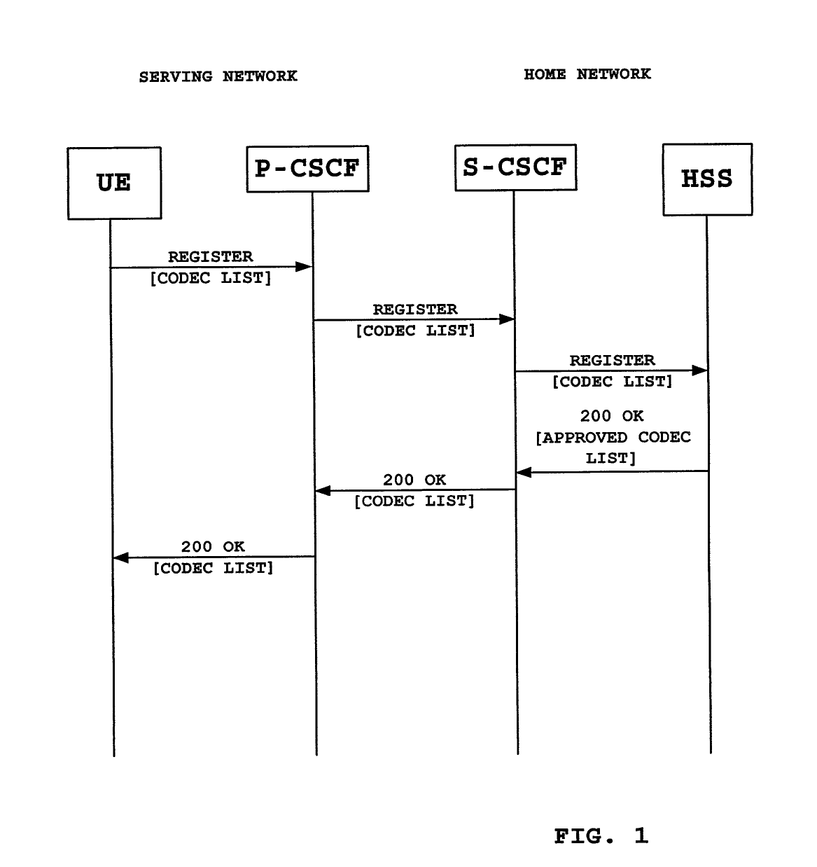

FIG. 1 shows the message flows for registering the media description capabilities in a preferred embodiment of the present invention.

Referring to FIG. 1, a user equipment UE sends a Session Initiation Protocol (SIP) registration message including its media description list. If the capabilities of the user equipment UE change, a new registration is sent with the updated list.

Based on the serving network capabilities the proxy call state control function P-CSCF first filters the list before sending it to the serving call state control function S-CSCF.

The serving call state control function S-CSCF forwards the registration onto the home subscriber service HSS. If this is a registration update wherein the serving call state control function S-CSCF has cached media description related subscription information, the serving call state control function S-CSCF may filter the media description list.

The home subscriber service HSS acknowledges the “REGISTRATION”-message. The home subscriber service HSS also checks the user's subscription against the registered media description lists. Media descriptions which are not being subscribed to are deleted. A shortened list is returned to the serving call state control function S-CSCF.

The serving call state control function S-CSCF also filters the list based on serving network capabilities. It is remarked that this is based on the assumption that a bearer would be routed through the home network. This may not be the case and thus, the serving call state control function S-CSCF would not do the filtering, i.e. roamers may not send the bearer through the home network, whereas home subscribers would. The filtered list is sent to the proxy call state control function P-CSCF.

The proxy call state control function P-CSCF forwards an “OK”-message and the filtered list to the mobile UE.

The above process is applicable to both originating and terminating mobiles. That is, the filters put in place during registration by a mobile may be used to filter (policy) sessions established to and from the mobile.

A more static model is also possible wherein the mobile provides no media description parameters (i.e. the first message of FIG. 1 provides no media description parameters). Instead, the serving network's proxy call state control function P-CSCF provides a list of media description types supported in the serving network for the type of mobile (e.g. home/roam) to the home network (actions related to the second and third message). The filtered list is then generated and returned to the proxy call state control function P-CSCF and the mobile (actions related to the fourth to sixth message). Thus, when creating “Invites”, the mobile can specify an already filtered set of media descriptions to be used. Alternatively, defaults may be embedded by the proxy on behalf of the mobile.

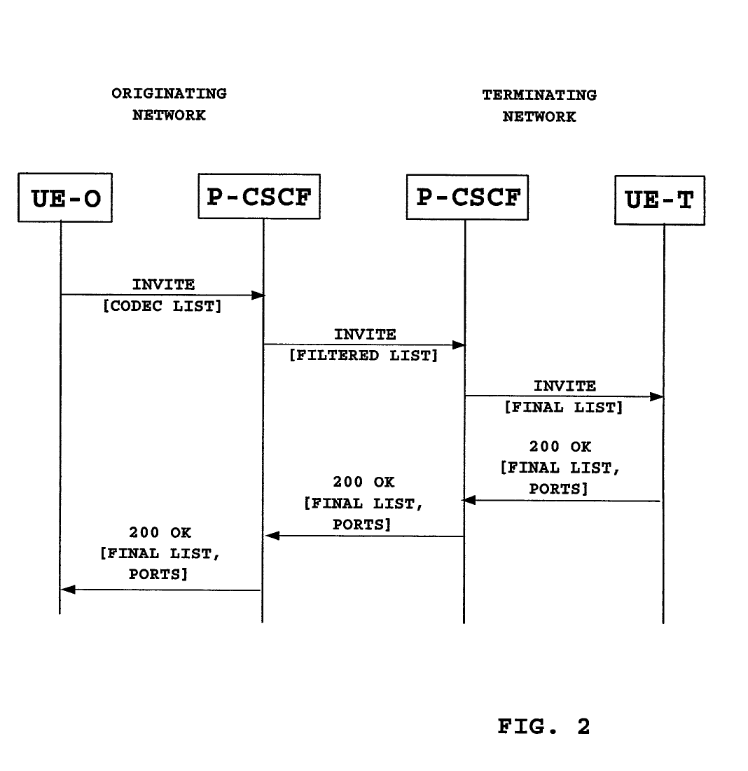

An example session establishment using these techniques is provided by the message flows as depicted in FIG. 2. It is remarked that for simplicity the serving and interrogating call state control functions (S-CSCF, I-CSCF) are not shown. It is the proxy call state control functions P-CSCF that are of importance in this process.

As shown in FIG. 2, an originating user equipment UE-O wishes to establish a session with another user equipment. An “Invite”-message is sent with the media streams which are relevant to the session specified. Only those values which are authorized for use by the subscriber and acceptable in the serving network are listed in the session description. This list was established during the registration process. If it was not established, i.e. not supported by the user equipment, then the proxy call state control function P-CSCF filters the list.

The proxy call state control function P-CSCF checks the media description list to verify that the serving network can support the requested mix of media description requirements as specified in the “Invite”-message. If not, it may alter them accordingly or reject the Invitation.

The “Invite”-message is routed to the proxy call state control function P-CSCF of the terminating mobile UE-T. Based on registered knowledge of the terminating mobile's media description capabilities (if not done prior in the terminating mobile's serving call state control function S-CSCF) and the current serving network capabilities, the terminating mobile's proxy call state control function P-CSCF further filters the media description list to a definitive set provided to the terminating user equipment UE-T. At this point the negotiation of media descriptions to be used may be complete. If the terminating UE-T and/or its home subscriber service HSS did not provide the serving and/or proxy call state control function with a filtered media description list for the terminating UE-T, then the proxy call state control function P-CSCF may only filter the list based on network capabilities.

The terminating mobile UE-T responds with a “200 OK”-message acknowledging-the media description selection and supplying port addresses for the media stream(s).

The “OK”-message is routed to the originating user equipment's UE-O proxy call state control function P-CSCF.

The originating proxy call state control function P-CSCF forwards the “OK”-message to the originating user equipment UE-O. The media description negotiation, which meets the policy constraints of the serving networks, is now completed end-end.

As a best mode of implementing the present invention it is presently considered that a network's serving call state control functions (S-CSCF) maintain the media description capabilities of the registered mobiles (like a visitor location register (VLR)) or subscribe to the information from the “REGISTRAR” (presence server tracking user locations) if it is a separate box. Further, the mobile registrations include the media description capabilities and do not provide media description parameters, but they however could if desired (i.e. devices which do not implement this feature could still send in the media description list). In case that the mobile sends its media description list, the call state control function filters down the list based on the current network capabilities and any other criteria such as preferred by the subscriber.

What is described above is a method of limiting the media description negotiation in Mobile IP networks, comprising the steps of: filtering, by a proxy call state control means P-CSCF, a media description list of a user equipment UE based on policy constraints of networks which are involved in a communication connection of said user equipment UE; and establishing a communication connection of said user equipment UE, wherein a media description list for said communication connection is negotiated by said proxy call state control means P-CSCF.

Although it has been shown what are presently considered as the preferred embodiments of the present invention, it is apparent to those skilled in the art that various modifications can be made without departing from the spirit and scope of the present invention.

1. A method of limiting the media description negotiation in Mobile IP networks, comprising the steps of:
filtering, by a proxy call state control means (P-CSCF), a media description list of a user equipment (UE; UE-O, UE-T) based on policy constraints of networks which are involved in a communication connection of said user equipment (UE; UE-O, UE-T); and
establishing a communication connection of said user equipment (UE; UE-O, UE-T), wherein a media description list for said communication connection is negotiated by said proxy call state control means (P-CSCF).

2. A method according to claim 1, wherein in a communication connection between two user equipment (UE-O, UE-T), the filtering step is executed at the originating user equipment's (UE-O) proxy call state control means (P-CSCF) and at the terminating user equipment's (UE-T) proxy call state control means (P-CSCF).

3. A method according to claim 1, wherein said user equipment's (UE; UE-O, UE-T) media description list is retrieved from a home subscriber service means (HSS), the home subscriber service means (HSS) then supplying the media description parameters for the user equipment (UE; UE-O, UE-T):

4. A method according to claim 1, wherein said media description list is submitted within a registration process of said user equipment (UE; UE-O, UE-T) in a network.

5. A method according to claim 4, wherein said media description list is stored in the proxy call state control means (P-CSCF) at the time of registration.

6. A method according to claim 4, wherein a serving call state control means (S-CSCF) maintains said media description list.

7. A method according to claim 4, wherein a serving call state control means (S-CSCF) subscribes to information provided by a presence server means for tracking user locations.

8. A proxy switching device for limiting the media description negotiation in Mobile IP networks, comprising:
filtering means for a media description list of a user equipment (UE; UE-O, UE-T) based on policy constraints of networks which are involved in a communication connection of said user equipment (UE; UE-O, UE-T); and
negotiation means for a media description list for said communication connection.

9. A proxy switching device according to claim 8, further comprising
means for retrieving said user equipment's (UE; UE-O, UE-T) media description list from a home subscriber service means (HSS).

10. A proxy switching device according to claim 8, further comprising
means for storing said media description list.

11. A Mobile IP network capable of limiting the media description negotiation, comprising a proxy switching device according to claim 8.

12. A Mobile IP network according to claim 11, further comprising a serving call state control means (S-CSCF) for maintaining said media description list.

13. A Mobile IP network according to claim 11, further comprising a serving call state control means (S-CSCF) for subscribing to information provided by a presence server means for tracking user locations.

14. A Mobile IP network according to claim 11, further comprising home subscriber service means (HSS) for supplying media description parameters for the user equipment (UE; UE-O, UE-T).

15. A Mobile IP network capable of limiting the media description negotiation, comprising a proxy switching device according to claim 9.

16. A Mobile IP network capable of limiting the media description negotiation, comprising a proxy switching device according to claim 10.
